(19) United States
(12) Patent Application Publication
(10) Pub. No.: US 2006/0168089 A1
(43) Pub. Date: Jul. 27, 2006

(54) Controlling incoming communication by issuing tokens

(76) Inventor: Scott E. Sampson, Orem, UT (US)

Correspondence Address: STOEL RIVES LLP - SLC, 201 SOUTH MAIN STREET, ONE UTAH CENTER, SALT LAKE CITY, UT, 84111, US

(21) Appl. No.: 11/368,583

(22) Filed: Mar. 6, 2006

Related U.S. Application Data
(63) Continuation-in-part of application No. 10/382,042, filed on Mar. 5, 2003, now Pat. No. 7,010,565.
(63) Continuation-in-part of application No. 10/671,087, filed on Sep. 25, 2003.
(63) Continuation-in-part of application No. 10/961,591, filed on Oct. 8, 2004.
(63) Continuation-in-part of application No. 11/230,747, filed on Sep. 20, 2005.
(60) Provisional application No. 60/415,321, filed on Sep. 30, 2002.

(51) Int. Cl. G06F 15/16

(52) U.S. Cl. 709/207

(57) ABSTRACT

A communication device is part of a communication system which is equipped with a token log. Tokens can be created by the operator of the communication device and issued to individuals who desire to communicate with the token issuer. Issued tokens are stored in the token log, potentially with settings that define how incoming calls or messages accompanied by a given token are to be automatically processed. When an incoming call or message is received, the communication system determines if a token is provided, if the token is valid, and possibly what settings are associated with that token in the token log. The communication system responds to the incoming communication according to the settings. Also, the communication system facilitates the issuance of new tokens to potential future callers.

### RELATED APPLICATIONS

This application is a continuation-in-part of U.S. patent application Ser. No. 10/382,042, filed Mar. 5, 2003, for “Communication Management Using a Token Action Log,” now U.S. Pat. No. 7,010,565, which claims the benefit of U.S. Provisional Application No. 60/415,321, filed Sep. 30, 2002, for “Function and Use of a Token Action Log,” both of which are incorporated herein by reference in their entirety. This application is also a continuation-in-part of U.S. patent application Ser. No. 10/671,087, filed Sep. 25, 2003, for “Electronic Payment Validation Using Transaction Authorization Tokens,” with inventor Scott E. Sampson, which application is likewise incorporated herein by reference in its entirety. This application is also a continuation-in-part of U.S. patent application Ser. No. 10/961,591, filed Oct. 8, 2004, for “Managing a Message Communication and File System,” with inventor Scott E. Sampson, which application is likewise incorporated herein by reference in its entirety. This application is also a continuation-in-part of U.S. patent application Ser. No. 11/230,747, filed Sep. 20, 2005, for “Methods for Managing the Exchange of Communication Tokens,” with inventor Scott E. Sampson, which application is likewise incorporated herein by reference in its entirety.

### COPYRIGHT NOTICE

© 2006 Scott E. Sampson. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71 (d).

### TECHNICAL FIELD

The present invention relates generally to communication systems. More specifically, the present invention relates to systems and methods for automatically managing incoming communications using tokens which are issued and stored in a token log.

### BACKGROUND OF THE INVENTION

The telephone has been a great invention. However, a drawback of having a telephone is the interruption of receiving incoming phone calls at less than convenient times. Further, incoming phone calls vary in their desirability. Some calls are considered highly valuable, warranting interruption of other activities. Other calls are undesirable under any circumstances, such as calls from telemarketers selling unwanted products. Other calls are in between on a desirable-undesirable continuum.

The use of “Caller ID” to screen calls is less than completely effective. It can be difficult to identify every caller from Caller ID, even wanted callers. Further, Caller ID only indicates the phone number of the calling phone but does not indicate who is using that phone or what his or her intention is.

A textual version of phone conversations is instant messaging or short text messaging, which involve holding a conversation using text instead of audible voice. Voice messaging can be integrated with text messaging to allow audible voice and/or text to be used in communication. IP (Internet Protocol) telephony is popular because it allows voice communication to occur very efficiently over public Internets. These various communication technologies have similar problems, in that all calls and messages coming to a recipient are not of the same value or interest to that recipient, and thus should not be treated in the same way.

What is needed is a technique to allow individuals and entities to automatically control how incoming calls and messages are received, rejecting unwanted calls and messages, and accepting others in ways that are appropriate for each given call or message.

### SUMMARY OF THE INVENTION

In one embodiment, this invention allows a person with a communication device, such as a mobile phone to automatically control what incoming calls are accepted or rejected and how accepted calls are handled. The communication device is configured to allow the person operating the device to issue tokens which are arbitrary symbols used to assess the desirability of future incoming phone calls. The issued tokens are distributed to individuals and organizations who may potentially call the operator of the communication device. The issued tokens are also stored in a token log, which may include information relating to each token. Callers who have been given access to issued tokens can use those tokens to communicate with the communication device for which the token was issued, or to communicate with other devices or systems which have access to a token log containing the issued token.

In another embodiment, the communication device used in this invention might be a computing device with the capability of receiving and sending text messages such as so-called instant messaging. In this embodiment the “caller” is the sender of the text message, who may have previously been issued a token by an operator of the text messaging device. The operator may have provided settings for the token which control the way the incoming message is handled. When the caller (i.e., sender) sends a message, a token previously issued by the recipient can be included with the message to have the sent message be treated in way that is controlled by the message recipient.

The application of this invention to voice telephony or text messaging is quite similar but with different terms for objects. Voice telephony (with text messaging counterparts) include: people with phones (text messaging devices) receive calls (messages) from callers (message senders). The application of the invention is the same in either instance, including people issuing tokens to others and storing the tokens in one or more token logs, and the others then being able to send the tokens back to the token issuers to gain a predefined type of access to the issuer's communication device. Throughout this disclosure, descriptions of the telephony embodiment should be considered to also pertain to text messaging, and vise versa.

The basic technology upon which this disclosure is based is disclosed in the patent applications in which this application is a continuation-in-part, as well as in U.S. Pat. No. 7,010,565 for “Communication Management Using a Token Action Log” and U.S. Pat. No. 6,804,687 for “File System Management with User-Definable Functional Attributes Stored in a Token Action Log.” The prior patents and patent applications covered the creation, issuance, storage, use, and retrieval of tokens for the purpose of automatically controlling incoming communication. Those patent applications covered various communication technologies including email, voice, and text messaging. This application describes features which pertain specifically to certain embodiments, including voice and instant messaging.

In particular, an operator of a communication device may create, store, and distribute tokens to enable others, such as callers, to initiate communication with the operator of the communication device. When a caller initiates a call to an issuer of a token and provides a previously issued token, one or more actions pertaining to the specific token can be accomplished based on one or more of: 1) the nature of the specific token as stored in the communication system in which the recipient's communication device is a part, 2) the reported or assumed status of the message recipient, 3) the functional status of the message recipients communication device, and 4) the purpose of the communication as indicated by the caller. These will be explained in the detailed description section.

### BRIEF DESCRIPTION OF THE DRAWINGS

FIG. 1 is a simplified diagram of a voice communication.

FIG. 2 is a simplified diagram of a text communication.

FIG. 3 is a block diagram of software modules within an embodiment of the invention;

FIG. 4 shows four different embodiments of the configuration of a token log.

FIG. 5 shows one embodiment of a procedure for processing an incoming call.

FIG. 6 shows one embodiment of settings for treatments and device states.

FIG. 7 shows one embodiment of a procedure for processing a caller purpose extension (CPE).

FIG. 8 shows one embodiment of a procedure for a message recording system.

FIG. 9 shows one example of a user interface in a mobile phone embodiment.

FIG. 10 shows one embodiment of how a token system can benefit an individual with multiple communication devices.

FIG. 11 shows a configuration of a token system in a multi-extension PBX system.

### DETAILED DESCRIPTION

In some cases in the following description, well-known structures, materials, or operations are not shown or not described in detail to avoid obscuring aspects of the invention. Furthermore, the described features, structures, or characteristics may be combined in any suitable manner in one or more embodiments.

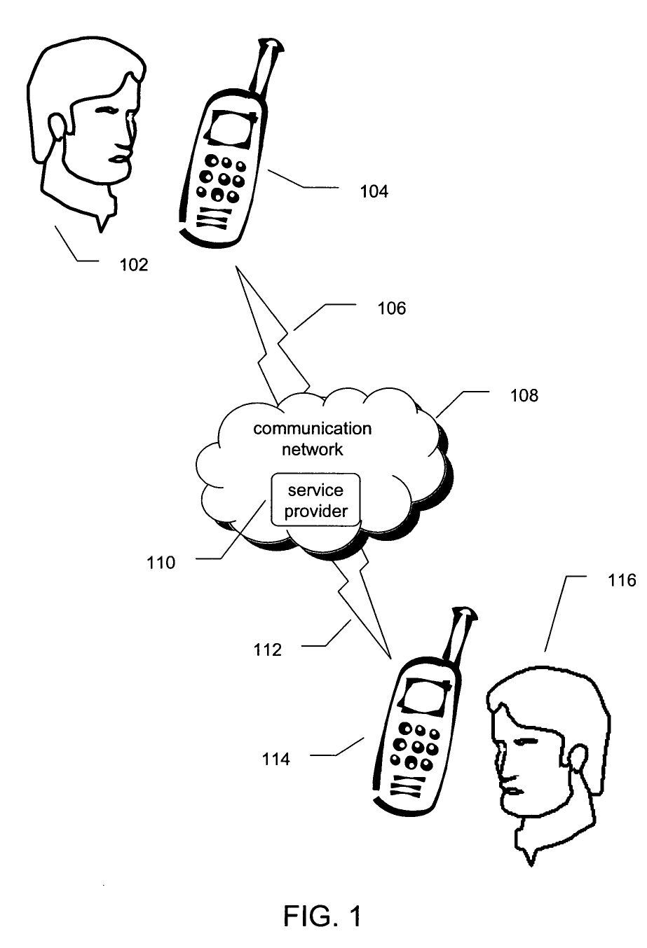

FIG. 1 shows a simplified diagram of voice communication using a voice communication system. FIG. 1 is provided to set forth common terminology and to enumerate elements which are valuable in a token-based system.

A caller 102 desires to call a designated recipient 116 and initiates a phone call by indicating the designated recipient 116 on the caller's communication device 104. The caller's communication device 104 might be a mobile phone, a wired (aka “land line”) phone, a computer, a personal digital assistant, or some other device capable of handling communication.

The initiated call is transmitted 106 to a communication network 108 by common signal transfer means, such as by electrical, radio frequency, microwave, and/or optical signals. The communication network 108 processes the call by routing it to a designated recipient 116. Note that the communication network 108 can consist of various public and/or private networks. The Internet is a common example of a public network that interacts with private networks.

In most situations, the communication network 108 includes a service provider 110 with which the recipient 116 (or the recipient's organization) has an account. Roles of the recipient's service provider 110 include processing incoming calls and assuring that calls are routed 112 to the appropriate recipient's communication device 114. The service provider 110 might provide recording services such as voicemail so that calls that do not reach the recipient 116 can be noted for later retrieval. In some instances the service provider 110 of the recipient 116 might be the same service provider used by the caller 102, but often they will be different. In some cases the service provider 110 is public and in other cases is private.

The combination of the recipient's communication device 114 and the service provider 110 with which the recipient has an account are collectively referred to as the recipient's communication system 110 and/or 114. This general specification is used because the functionality of this invention can reside on the recipient's communication device 114 and/or on processing equipment of the recipient's service provider 110.

The calls for a designated recipient 116 are usually (but not always) transmitted 112 to a recipient's communication device 114, which device also might be a mobile phone, a wired phone, a computer, a personal digital assistant, or some other device capable of handling communication. The recipient's communication device 114 might be similar in type to the sender's communication device 104, but is often different.

The recipient's communication system 110 and/or 114 can act upon the incoming call in any of various ways, including but not limited to providing an audible signal at the communication device 114 in order to notify the recipient 116 of an incoming call. The primary purpose of this invention is to allow message recipients 116 to define and control the automatic actions taken in response to incoming communications from senders.

The invention allow a recipient 116 to control how incoming communication is processed by recipient's communication systems 110 and/or 114. This is accomplished by having the communication system 110 and/or 114 issue tokens to potential callers 102 and storing the tokens in a token log within the communication system 110 and/or 114. The token issuer might also define one or more settings associated with given tokens, which settings specify how the communication system 110 and/or 114 responds to an incoming communication when the incoming communication is accompanied by the issued token.

There are various ways the communication system 110 and/or 114 can respond to an incoming call. As mentioned, the communication system 110 and/or 114 can provide an audible signal to notify a recipient 116. Alternately, the communication system 110 and/or 114 can signal a recipient by non-auditory means such as vibration or light signaling, so as to not disturb others near the recipient's communication device 114. The recipient's communication system 110 and/or 114 can alternately forward the call to a message recording system such as voicemail, or forward the incoming call to one or more alternate communication devices or addresses. Or, the communication system 110 and/or 114 might reject the incoming communication, optionally providing a response message back to the caller 102.

The appropriate response to take for incoming calls can be dependent upon many conditions, including the following: 1) the nature of the specific token as stored in a token log within the communication system 110 and/or 114 used by the recipient, 2) the reported or assumed status of the message recipient 116, 3) the functional status of the message recipient's communication device 114, and 4) the purpose of the communication as indicated by the caller 102. These four action conditions are explained in the following paragraphs.

First, when a recipient 116 issues a token to a potential caller 102, the token is stored in a token log within the recipient's communication system 110 and/or 114, optionally being stored in association with an indication of one or more potential actions to be taken by the communication system 110 and/or 114 in response to an incoming call to the designated recipient 116. For example, specific tokens might be classified according to treatment, with a given treatment specifying a set of one or more conditions and actions.

Treatments can be associated with specific tokens within a token log so that incoming calls accompanied by given tokens will be treated in a desired way. Also, communication system operators may have the opportunity to change the treatment associated with a given token. For example, a woman might issue the token “3275” to her boyfriend and associated a “VIP” treatment with that token in a token log within her communication system. That way, when the boyfriend provides that token with an incoming call, the call will be given a welcoming treatment. The boyfriend might store the token with her phone number in the address book of his communication device. The woman may decide to jilt the boyfriend and tell him to “take a hike.” But, the boyfriend may continue to call from various communication devices and have his friends call her as well using the token. Note that since he is calling from various communications devices the “Caller ID” method of identifying his incoming calls will be thwarted. By simply changing the treatment of the “3275” token from “VIP” to “filter,” future incoming calls with that token will be filtered and not bother the woman.

The actions associated with a given treatment might be predefined in the communication system and might be modifiable by the user or operator of the communication device. Further, users might be allowed to extend the range of treatments available for use, and may define new treatments based on old treatments. For example, the woman of the prior scenario may have various boyfriends and define a “groovy” treatment for favored boyfriends and a “jerk” treatment for disfavored boyfriends or former boyfriends. Calls coming in with a “groovy”-treatment token can produce a pleasant ring tone, and calls coming in with a “jerk”-treatment token can be forwarded to voicemail or diverted to a prerecorded rejection message.

Other examples of treatment functionality will be described later in this disclosure. The actions associated with a given treatment will usually be based on conditions surrounding the given call, including the status of the recipient, the status of the recipient's communication device, and the caller's reported purpose for the call.

A second factor in determining how the communication system should handle incoming calls is the reported or assumed status of the designated call recipient. Basic system statuses might be “available,” meaning available to receive a call, or “unavailable,” meaning not available to receive a call. The recipient might indicate his or her current status through the user interface of the communication device by setting the “mode” of the communication device. Or, the recipient status might be assumed according to a predefined mode schedule. For example, the recipient's communication system might assume a mode of “unavailable” during normal sleeping hours and “available” otherwise. If the operator of the communication device is in a meeting, he or she may temporarily set the mode of the communication device to “unavailable” mode or a more specific “meeting” mode.

Other examples of recipient statuses include “at work,” “in class,” “at home,” “on vacation,” and so forth. The operator of the communication device might define additional statuses, with new status inheriting actions from other statuses and/or having distinct actions. The specific way the recipient's communication system handles incoming messages might be dependent upon the recipient status as registered as a mode on the communication device.

A third factor in determining how the communication system should handle incoming calls is the operational status of the communication device, which is what the device is doing at the time of processing an incoming call. Usually a communication device is idle, meaning that it is not occupied doing some other task such as handling a call. A second device status might be busy, implying that the device is busy handling a call. A third device status might be off, indicating that either the communication device is turned off or that it is temporarily disconnected from the communication network (such as a mobile phone out of range from any transmission tower). A fourth device status might be unanswered, which means that the device has not been answered after a specified number of rings.

The fourth potential factor in determining how the communication system should handle incoming calls is the intended purpose of the caller in initiating the communication with the recipient. A given caller may sometimes call for urgent or emergency communication, and at other times call with less urgent purposes. For example, parents may provide a token to a babysitter before going to dinner and the opera. The babysitter may initiate a call to the parents to report a phone message of minor importance. If the parents' communication device is in an available mode, then that call will cause the communication device to signal the intended recipient, but if the phone is in an unavailable mode, the signal will be suppressed. If the babysitter calls about an emergency, e.g. to report that the house is on fire, the babysitter might enter a call-purpose code indicating the urgency of the call, which code would cause the communication device to provide an signal even if the communication device is in an unavailable mode.

In one embodiment, caller purposes might include a “regular priority” such as to initiate a conversation, and a “urgent priority” such as to report an emergency. Other embodiments may include other caller purposes, including ad hoc and user-definable purposes. For example, a caller who is a friend of a call recipient may have a standing plan for a weekly golf game on Friday afternoons. The caller may call the call recipient each Friday morning to either confirm the golf appointment or cancel the appointment, and the caller may communicate a “golf-yes” caller purpose for the former and a “golf-no” caller purpose for the latter. The call recipient's communication system may be configured to handle the call differently given each different caller purpose, perhaps accepting the call if a “golf-no” caller purpose is indicated but only noting the call if a “golf-yes” caller purpose is indicated.

One way a caller may indicate his or her intended purpose for calling the sender is for the caller to augment the communicated token with one or more symbols which correspond to a specific purpose, which we refer to as a caller purpose extension (CPE). For example, the asterisk symbol (also called the star symbol) “*” might be added to a token to indicate urgent (e.g., emergency) communication. If the system was a phone system, the babysitter in the above example would call the parents about an emergency by entering the parents' phone number, the appropriate token, and the “*” caller purpose extension. The parents' phone may then respond differently than it would if no caller purpose extension were provided by the caller.

Another possible caller purpose extension can be used by callers who do not want to directly communicate with the called recipient, but would rather just leave a message for the recipient. In a phone system, the pound sign “#” might be used for that purpose. A “message only” caller purpose extension could keep the recipients communication device from immediately signaling the recipient, but instead transfer the caller to a message recording system.

FIG. 1 depicts an embodiment involving voice communication. However, voice communication devices such as mobile phones are commonly equipped with digital cameras and have the ability to transmit image and video messages. The processes of issuing tokens to potential callers (e.g., senders of images and/or videos), storing tokens in token logs, and using tokens arriving with incoming communications can likewise pertain to image and video messages.

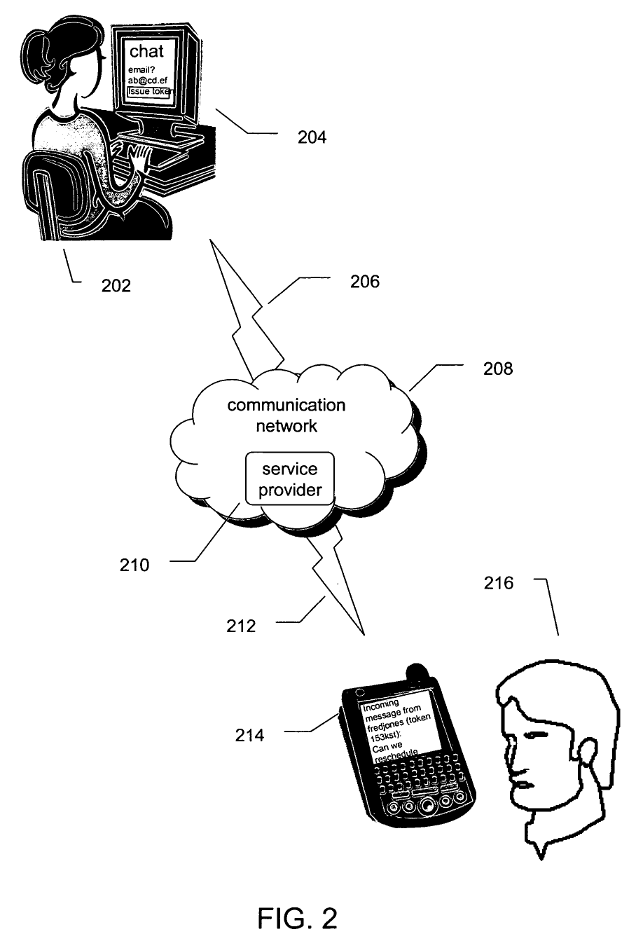

To emphasize that this invention is not limited to voice communication, FIG. 2 is provided to illustrate how all of the elements of FIG. 1 might be found in a text communication system. The “caller” 202 in this case is person operating some type of text communication device 204, such as an instant messaging system, a short text messaging system, a text chat system, or other system that facilitates the communication of textual messages. Note that in some embodiments the communication device 204 allows for multiple methods of communication, including two or more of text, voice, video, and graphical symbols.

Note that we use the term “caller” to refer to the initiator 202 of a text communication just as we would use the term “caller” to refer to the initiator 102 of a voice communication. We might have alternatively referred to the text caller 202 as a “sender,” but will use the term “caller” instead. Throughout this application the term “caller” and the term “sender” are synonymously used to describe a person who initiates a communication to a recipient. Likewise, a communication of voice, text, or other types may be generically referred to as a “call.”

When the caller 202 initiates a communication to the recipient 216 via the caller's communication device 204, the communication is transmitted 206 via any of various means to a communication network 208. In some embodiments, the communication network 208 includes a service provider 210 with which the recipient 216 has an account. The service provider 210 may process communication requests intended for the recipient 216, or/or may forward 212 the communication requests to the recipient's communication device 214.

The recipient's communication device 214 presents the incoming communication to the recipient 216. To illustrate the generality of communication types that can be used by this invention, note that in some embodiments a text message provided by a caller 202 may result in an audible message being presented by the recipient's communication device 214. Again, the purpose of FIG. 2 is to illustrate that although one embodiment of this invention may involve voice communication (e.g., FIG. 1), and other embodiments may involve textual or other types of communication (e.g., FIG. 2).

Another embodiment may accommodate the communication of image messages, such as facsimile (fax) transmissions. Under such an embodiment a caller 202 may use an image sending device (e.g., fax machine) 204 to transmit 206 a document image through a communication network 210. The communication network routes and transmits 212 the message to a document image device (e.g., another fax machine) 214 belonging to a recipient 216. The recipient 216 would create and issue tokens to potential senders of image messages (e.g., faxes) and store those tokens in a token log within the communication system 210 and/or 214. Callers with a valid token could access the recipient's communication device 214 and transmit image messages. Senders of so-called “junk fax” messages would not have a valid token, and thus could be prevented from sending messages to the recipient's communication device 214. Note that in FIG. 2 the communication devices 204 and 214 are represented by generic images, although in various embodiments the communication devices would have different physical appearances.

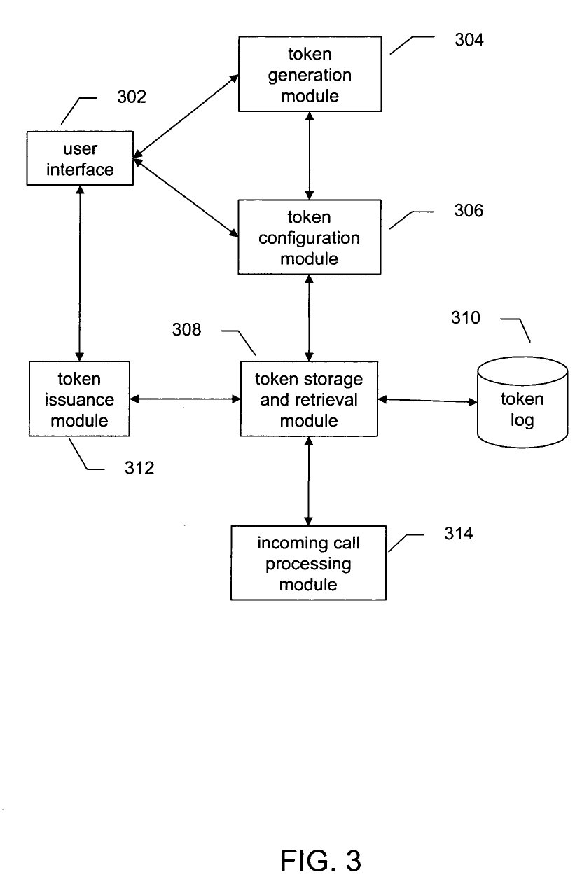

FIG. 3 shows software modules that provide functionality of this invention within a communication system in one embodiment of this invention. A user interface 302 allows an operator to configure the system. A token generation module 304 creates a new token at the request of the operator. The token is typically created as an arbitrary set of one or more symbols. In a embodiment within a phone system, the tokens might simply be sequences of numbers. In other embodiments, tokens might be composed of a variety of numbers, letters, and/or other symbols.

Once a token is generated a configuration module 306 may be provided to allow the operator to specify options and settings to be associated with the given token. Through the user interface, the configuration module presents the operator with options for the token, and accepts the operator's preferences.

Once any options or settings are specified, the token storage and retrieval module 308 stores the token in the token log. That module can also retrieve a previously stored token so that settings may be modified and re-saved.

A token issuance module 312 responds to user commands to provide a token for issuance to a potential caller. The token issuance module 312 may simply provide a token to the operator through the user interface 302 so that the operator can distribute the token as desired. Or, the token issuance module 312 may automatically issue the token to one or more possible callers. For example, in a text messaging embodiment, pressing an “issue token” button while the caller is connected may cause this module to transmit a token to the caller. The token issuance module 312 may also record the ID of the person to whom the token is issued.

An incoming call processing module 314 detects an incoming call and identifies tokens accompanying incoming calls. If no token is detected with an incoming call, then the incoming call processing module 314 may assume that a “tokenless” token has arrived with the call, which is a special token with settings and options that are to be used when a call comes in without a token. For example, under one scenario, the user may desire that callers without tokens be allowed to leave a short message indicating who they are and why they are calling. The user may then decide whether to issue a token to that person or ignore the request.

If a token is detected with the incoming call 314, then the token storage and retrieval module 308 can lookup the received token in the token log 310, and the call can be processed 314 according to any settings or options associated with the given token.

The various elements of FIG. 3 can exist at different places within the recipient's communication system 110 and/or 114. In some embodiments, the elements of FIG. 3 exist within the recipient's communication device 114. In some embodiments one or more of the elements of FIG. 3 exist within the system of the service provider 110 or within systems accessible by the service provider. In some embodiments one or more of the elements of FIG. 3 exist both in the recipient's communication device 114 and in the system of the service provider 110.

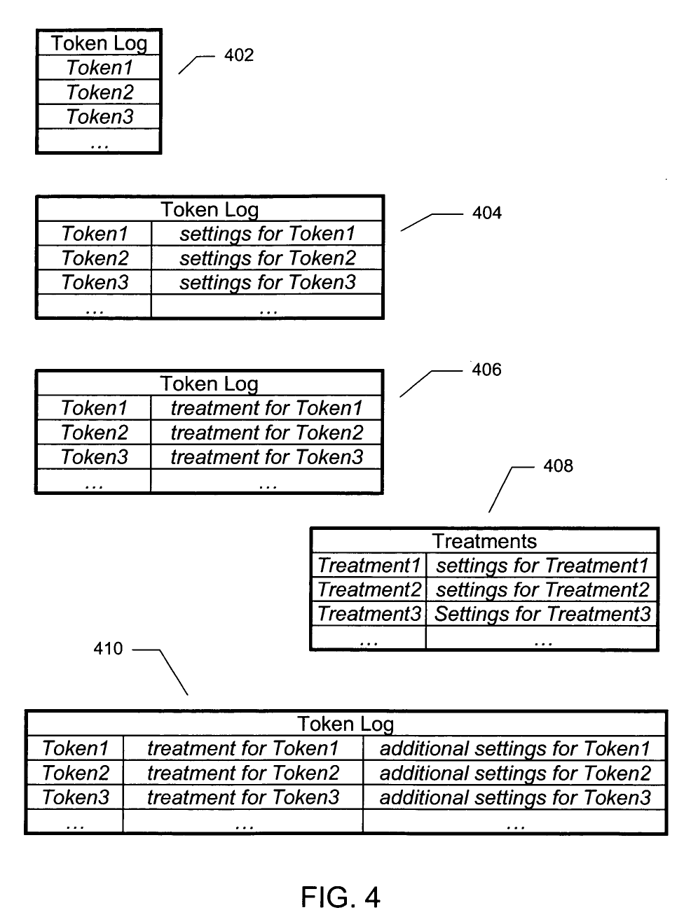

FIG. 4 shows four examples of the configuration of a token log 310 that may be used in different embodiments of the invention. One key feature of any token log is that it stores tokens which have been created within the recipient's communication system.

Token log 402 is the simplest example of a token log, since it may only contains tokens, in one embodiment. Again, tokens are sets of symbols. For example, “Token1” might be “2935,” “Token2” might be “84ab,” and so forth.

Token log 404 is an example which allows each token to be associated with one or more settings which define how the system 314 responds to incoming calls. A wide variety of possible settings can be incorporated into various embodiments. In some embodiments, settings might include one or more of the following:
Default audible signal style. (The audible signal to be used to notify the recipient of an incoming call.)
Default inaudible signal style. (The signal style to be used for inaudible signaling of the recipient, such as visual signaling or vibrating.)
Signal repetitions or duration. (The duration or number of times to signal the recipient of an incoming call before concluding that the recipient will not take the call.)
Recording duration. (The amount of recorded message the caller is allowed to leave at any one time.)
Allowed caller purpose extensions. (Which caller purpose extensions are allowed for incoming calls.)
Urgent signal style. (A signal style to be used for calls designated as urgent.)
Urgent forwarding. (Whether incoming calls identified as urgent should be automatically forwarded to another communication device if the recipient does not answer the call.)
Regular unanswered forwarding. (Whether incoming calls not identified as urgent should be automatically forwarded to another communication device if the recipient does not answer the call.)
and so forth.

A “signal style” could identify a signal pattern and/or intensity. For example, a common signal style for urgent calls might be an invigorating musical melody that gradually increases in volume.

Other settings may pertain to conditions under which a given token can be considered valid. For example, some tokens might be limited to being valid only if they come from a defined set of callers (as indicated by the caller's network identifier such as a phone number detected by caller ID). Other tokens might be limited to a specific number of uses by callers, or limited to a specific time duration for use by callers. For example, a person may issue a token to a sales organization to allow a salesperson to contact the person to transact immediate business. After the immediate business, the person may not want to hear from the salesperson. Therefore, the person might specify that the token is valid for a given duration, after which the token either becomes invalid or changes treatment to a filtering treatment.

A wide variety of settings might be associated with a given token. However, it would make practical sense to limit the setting options presented to the system operator to a relatively small useful set.

Another way to simplify the configuration of user settings is to allow system operators to associate tokens with standard treatments in a token log, as depicted in 406. Each treatment is associated with one or more settings 408 so that associating a token with a given treatment 406 thereby associates that token with the settings associated with the treatment 408. In this way, the operator does not have to define each setting option for a given token, but can categorize tokens according to standard treatments.

The treatments shown in 408 might be defined according to the type of person to whom a corresponding token is typically issued. Examples include the following:
Regular—issued to individuals of no distinctive importance.
VIP—issued to very important persons whose calls should receive special treatment. Settings may include providing a distinctive audible signal and allowing urgent caller purpose extensions.
Coworker—issued to coworkers who typically call about work related issues. Settings may include suppressing audible signaling for incoming calls that come in while the recipient is on vacation.
Student—issued to students of the recipient. Settings may include transferring calls that occur outside of working hours directly to a message recording system.
Filter—issued to individuals and companies that the recipient does not want to be directly bothered by. Settings may include directing all calls directly to a message recording system.
and so forth.

Treatments 408 might be predefined in the system and/or might be user configurable. An advantage of user configurable treatments is the ability for the system operator to customize the token system according to preferences. The list of treatments may also be user extensible. For example, some users may have different types of VIP treatments, for spouse, boss, etc. The use of treatments facilitates easy of use for system operators.

The fourth token log 410 shown in FIG. 4 shows an embodiment wherein tokens are associated with treatments within a token log, but also may associate specific tokens with settings which override the default settings provided by the treatment. This token log configuration provides the simplicity of 406 and 408 with the flexibility of 404.

Any of the token log examples in FIG. 4 might also contain metadata about each token, such as the day and time the token was created, comments or description about how the token was distributed, etc. Further, the system may contain additional tables; for example, a table that links specific tokens to specific caller IDs might be useful for identifying if the token is sent from an expected caller, or useful for reissuing tokens to potential callers.

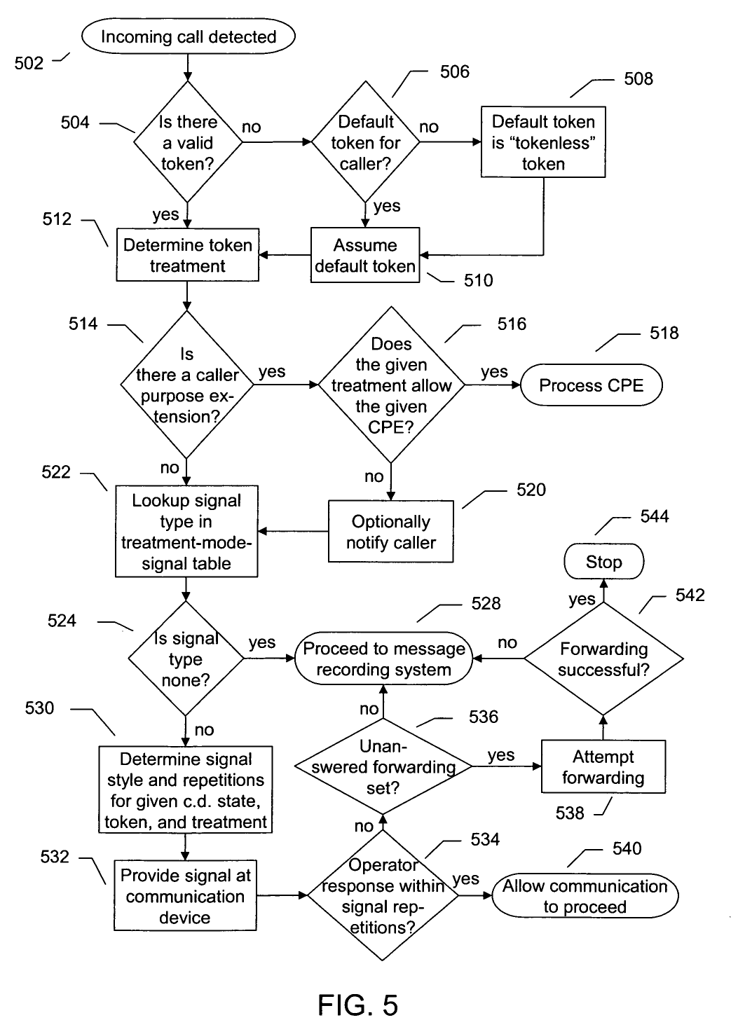

FIG. 5 shows a procedure for processing an incoming call, in one embodiment of this invention. It is intended for illustrative purposes, and in other embodiments steps may be omitted or additional steps may be added.

When an incoming call is detected 502, the incoming call processing module 314 determines if the incoming call is accompanied by a valid token 504. A valid token is one which is stored in a token log within the recipient's communication system 110 and/or 114, having any use conditions met. The means by which a token is included with the incoming communication is not limited in this disclosure. In a phone context the incoming token might be communicated from a caller as standard DTMF signals, as digital signals, etc. In a text messaging context the caller might communicate a token by appending it to the recipient's identifier, by imbedding it in the communicated message, etc.

If it is determined that the incoming call has no token, then it might be determined if a default token exists for the given caller 506. For example, individuals whose caller identification is recorded in the recipient's phone or address book might have one or more specific default tokens. If there is no default token for the given caller, then a “tokenless” token 508 might be used as the default token. The “tokenless” token might go by any name, and serves the function of providing token functionality for calls without a token. The user would usually be given the option of specifying treatments and/or settings associated with the tokenless token. The appropriate default token is assumed for the communicate that arrived without a token 510.

In this embodiment we assume that tokens can be associated with treatments. The treatment for the given token is determined 512 by looking the token up in a token log.

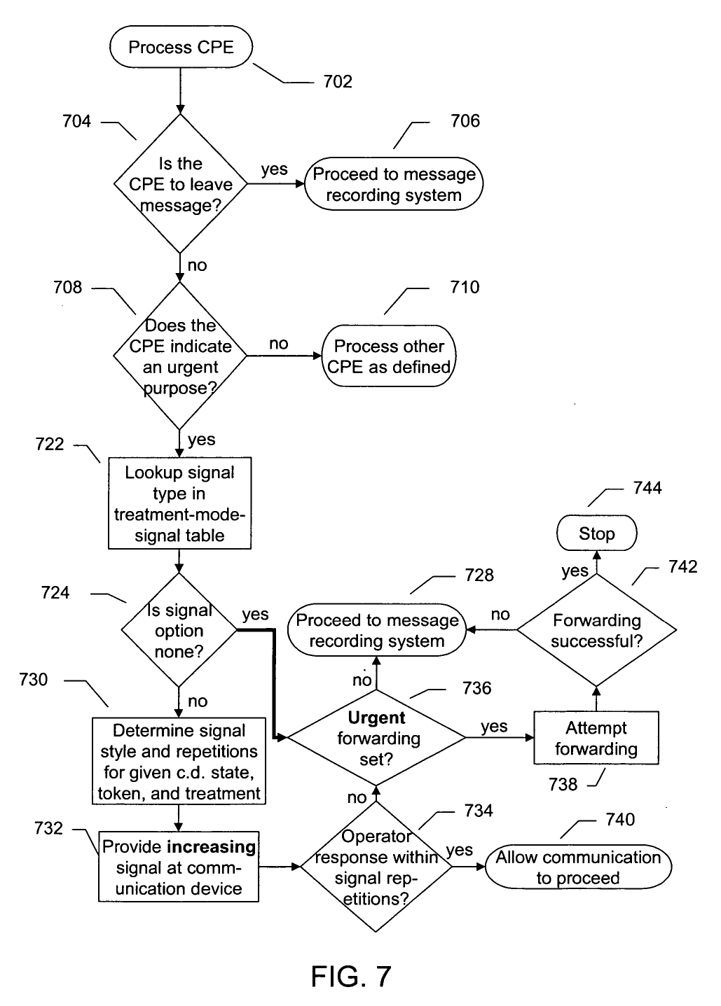

In this embodiment we also provide provisions for caller purpose extensions (CPEs). If the incoming call has a CPE 514 then the system might check whether the given treatment allows the given CPE 516. If the given treatment does not allow the given CPE, then the system might optionally inform the caller about such 520, and then ignore the CPE while continuing. If the given treatment allows the provided CPE then the procedure processes the CPE 518 which is described in FIG. 7.

One of the possible settings associated with a given treatment 408 might be the type of signal to provide via the recipient's communication device, possibly based on conditions such as the state of the communication device 114 and indicated mode of the recipient 116. The communication device state might be idle (ready to receive a communication), busy (currently engaged in processing a communication), off (power off or simply off from communicating 112 with the network 108), etc.

As mentioned, the state of the recipient 116 may be indicated within the communication device 114 according to a mode setting. Examples of mode setting include the following:
working—a mode to indicate the recipient is supposedly at work.
meeting—a mode to indicate the recipient is supposedly in some kind of meeting.
driving—a mode to indicate the recipient is supposedly driving a vehicle.
home—a mode to indicate the recipient is supposedly not at work.
sleep—a mode to indicate the recipient is supposedly asleep.
vacation—a mode to indicate the recipient is supposedly on vacation.
and so forth.

The modes are simply an indication of the assumed state the recipient is in at the given time. An operator of the communication device 114 may alter the modes at will, even if the set mode is not representative of what is his or her actual status. In one embodiment, the communication system 110 and/or 114 might be configured to automatically set the mode based on the day and time. For example, on weekdays at 8:00 a.m. the system might automatically assume working mode, at 5:00 p.m. the system might automatically assume the home mode, and at 10:00 p.m. the system might automatically assume the sleep mode. This automatic mode sequence might be suppressed or overridden when the system is in vacation mode.

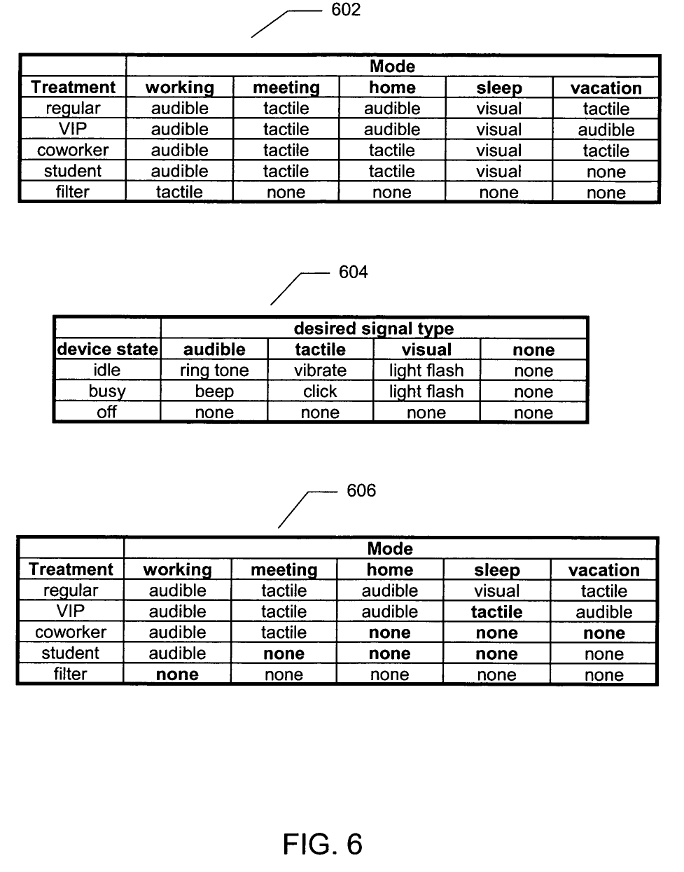

The value of modes in a token system is that given tokens with given treatments can provide automatic behavior that changes according to the current mode and device state. FIG. 6 shows an example treatment-mode-signal table 602 which indicates what signal type should be used when an incoming call contains a token with a given treatment and when the communication device is in a given recipient mode. For example, when a token arrives having a VIP treatment indicated in a token log, and the recipient's communication device is in vacation mode, the device is to provide an audible signal to the recipient. For simplicity, table 602 shows only one signal type per treatment-mode pair, although some embodiments would allow multiple simultaneous signal types (e.g., audible+tactile for VIP calls while in working mode).

We previously described how the mode could be manually set by a system operator or automatically set according to a predefined schedule. (For example, the system automatically enters “sleep” mode at 10:00 p.m. every evening.) In some embodiments, the treatment or treatments assigned to given tokens 404 might change according to a predefined schedule, such as a token assigned a “student” treatment which automatically changes to a “filter” treatment after the end of the school semester.

Table 604 shows how different signal types might operate in a phone embodiment. An audible alert would produce a ring tone when the device is idle, or a beep when the device is busy handling a communication. This set of signal types (audible, tactile, visual, and none) are just an example of possible signal types, with other signal types available in other embodiments.

Table 602 might be the treatment-mode-signal type table for a typical user. Table 606 shows a possible treatment-mode-signal type table for an individual who rarely wants to be bothered by unimportant incoming calls. The signal types shown in bold are different from corresponding elements of 602, allowing fewer types of calls to provide audible and inaudible signals, but also having tactile signaling for VIP callers during sleep mode. The point is that a communication device operator could provide settings for treatments and tokens according to personal preferences.

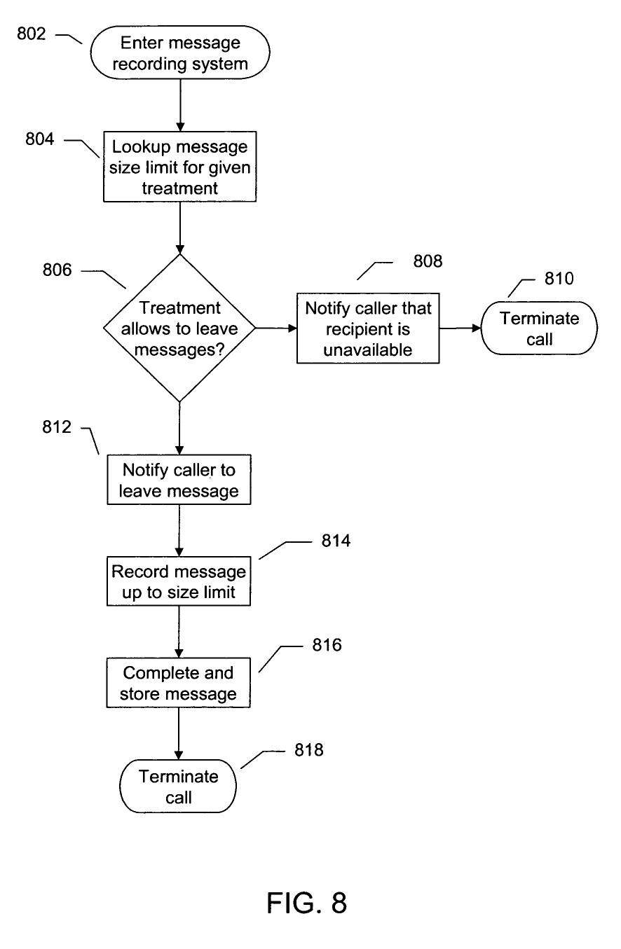

We see in FIG. 6 that one possible signal type is “none,” meaning the communication device is not to signal the recipient. When the signal type is “none” 524 the call could be transferred to a message recording system 528, an example of which is described in FIG. 8, or the call could simply be terminated.

If there is to be a signal, then the signal style (e.g., signal sound and/or volume) is determined 530, which again can be defined by settings of the treatment and/or token. For example, the token given to one's grandparents might have a setting to play the tune “Those were the days” to signal incoming calls. The designated signal is provided at the communication device 532 for the specified duration 534. If the recipient (or another person) answers at the communication device, then the communication proceeds 540 which is to say the call goes through.

If the call is not answered 534 within the specified duration, the system might check to see whether unanswered calls should be automatically forwarded to another communication device 536. Forwarding might be attempted 538, and if successful then the processing may be complete 544, but if unsuccessful then the incoming call might be transferred to a message recording system 528.

FIG. 7 shows one embodiment of a procedure to process a caller purpose extension (CPE). It starts 702 with CPE having been detected. This example specifically considers “leave message” and “urgent” CPEs, although in other embodiments other types of CPEs are sure to exist.

If the CPE indicates that the caller simply desires to leave a message 704, then the call is forwarded to the message recording system 706, an example of which is depicted in FIG. 8. If the CPE indicates that the caller considers the purpose to be urgent 708, then a call handling procedure somewhat similar to that shown in FIG. 6 is performed. Other CPEs would be handled as appropriate 710.

The example of handling an urgent CPE 722-744 is similar to the procedure for handling a regular call 522-544, with differences shown in FIG. 7 in bold. First, if the signal option happens to be none 724, then instead of proceeding directly to the message handling system 728, urgent call forwarding is first attempted 736. Also, when a call signal is provided by the communication device 732, this embodiment shows an increasing signal, meaning that the signal may increase in intensity or speed. This is just one embodiment of an urgent call handling procedure, to illustrate possible functionality defined within the scope of this invention.

FIG. 8 shows one possible embodiment of a message recording system. When a call is transferred to the message recording system 802, this embodiment assumes that an appropriate token has been identified and that it has a given treatment. Alternately, the token itself could have its own settings, as depicted in 404 or 410.

One treatment setting considered in this embodiment allows each treatment to have a specific limit on messages 804. For voice messages this may be specified in terms of maximum number of seconds per recorded message. For text messages this may be a specific number of characters or overall message size.

Also, some treatments may allow recipients to leave messages, but other treatments may not. For example, a “salesperson” treatment may be assigned to tokens given to salespeople; if the communication device operator desires to not allow salespeople to leave messages, then they could set the maximum message size to zero, in which case the message recording subsystem might notify the caller that he or she cannot leave a message 808 and then terminate the call 810.

If the given treatment allows leaving messages, then the caller might be given instructions to leave a message 812, a message can be recorded 814 and stored 816, and the call can be terminated 818. Of course, other functionality of a message recording can be implemented. The unique element of this invention is the way in which tokens and token settings can alter the way in which the communication system handles incoming calls.

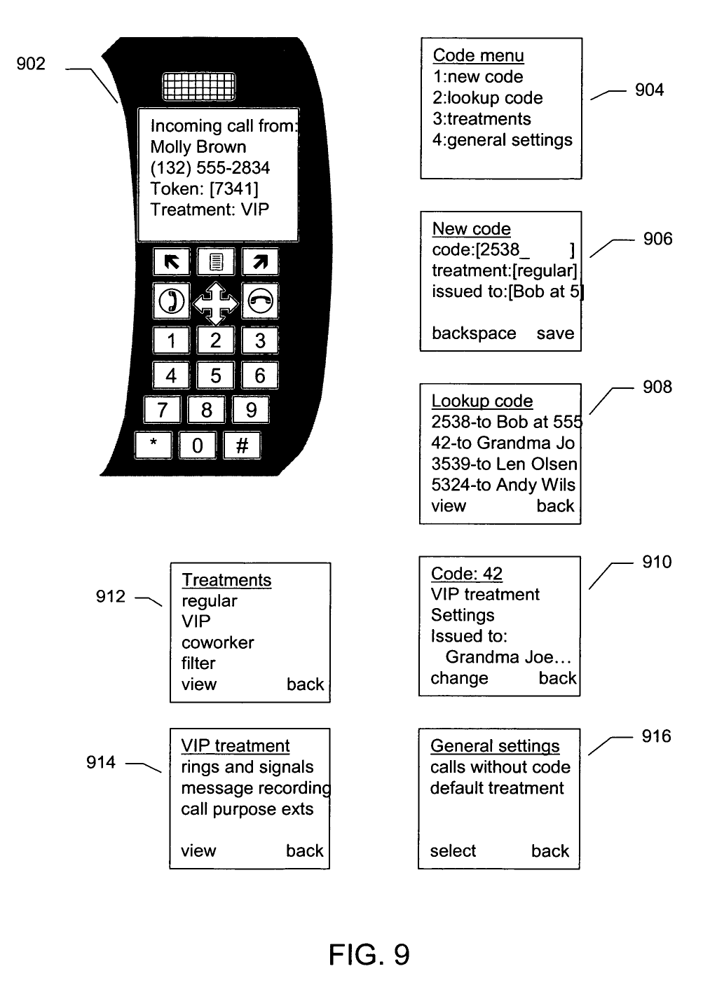

FIG. 9 shows an example of a user interface in a mobile phone embodiment. The primary FIG. 902 is a somewhat crude depiction of a mobile phone, and actual mobile phone embodiments will look more similar to mobile phones in actual use. The display of 902 depicts things a mobile phone user interface may include when a call comes in. Note that the caller “Molly Brown” included the token “7341” which the device operator previously assigned a “VIP” treatment within a token log. Therefore, the recipient's communication system will handle the incoming call according to the settings of the “VIP” treatment.

The other items in FIG. 9 depict other possible types of display information in one particular mobile phone embodiment of this invention. The 904 display shows a possible token menu which is called a “code menu”—the term “code” means “token” but is likely to be more intuitive of a term to non-technical users than the term “token.” The “code menu” allows an operator to create a new code for distribution to possible future callers, to lookup a code and possibly modify the code, to view and change treatments, and to specify general settings.

The display 906 depicts the creation of a new code in one embodiment. The system might generate the new code and/or allow the operator to specify the code. The operator can specify the treatment, or simply use a default treatment. The operator may also indicate to whom the code (i.e., token) has been or will be issued, for later reference.

The display 908 depicts a list of codes in one embodiment. The screen size only allows displaying a small number of codes, but the user would be allowed to scroll down the list with navigation buttons on the phone, or search for a specific code. The operator can select a specific code, as depicted in display 910. The operator can view and/or modify information about the code, such as the treatment or issuance (i.e., an indication of who the code was previously issued to).

The display 912 depicts viewing a list of treatments in one embodiment. The display shows some treatments defined in the system, and a menu function might allow adding additional treatments. If the user selects a given treatment, such as the “VIP” treatment, the display 914 can allow the operator to view and/or modify information about that treatment. In this example, the operator can modify treatment settings pertaining to rings and other signals, message recoding, and caller purpose extensions. In other embodiments the settings and options for treatments would differ.

Finally, display 916 depicts some general settings for the code system, such as how to handle calls coming in without a code and what default treatment to use for new codes (i.e., tokens). The displays shown in this embodiment are for illustrative purposes.

One particular advantage of having a token creation and storage system within a mobile communication device is that the system can also be used to issue tokens to vendors as the basis for authorizing financial transactions. That embodiment is described in U.S. patent application Ser. No. 10/671,087, filed Sep. 25, 2003, titled “Electronic Payment Validation Using Transaction Authorization Tokens,” of which the present application is a continuation-in-part.

Again, in some embodiments, the token log is stored within the communication device 902, and in some embodiments the token log may be stored at a location accessible by the communication device. The advantage of keeping the token log at a location outside of the communication device is that such facilitates having the token log relate to multiple communication devices, as depicted in the next example.

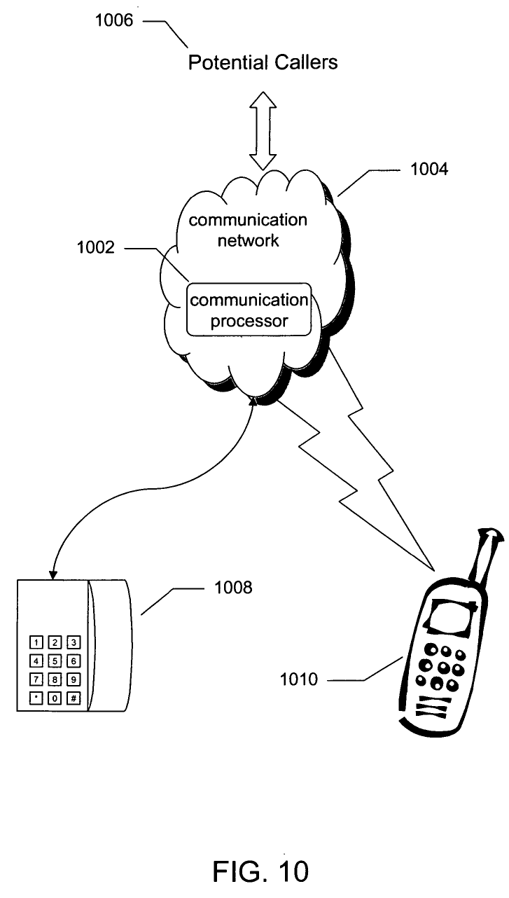

FIG. 10 illustrates a benefit of a token system in an embodiment in which an individual has multiple communication devices. In this embodiment, a communication processor 1002 exists within a communication network 1004. Potential callers 1006 can access the communication processor 1002 by communicating through the communication network 1004. In this example, the communication processor 1002 is responsible for routing calls from potential callers 1006 designated for a recipient with two communication devices 1008 and 1010. In this example, the first communication device 1008 is depicted as a telephone connected by wire to the communication network 1004, and the second communication device 1010 is depicted as a mobile phone connected to the communication network by wireless signals. The first communication device 1008 may be located in a home or office, and the second communication device 1010 may be kept with the operator of the device.

A potential caller 1006 may call the first communication device 1008 of the designated recipient. The potential caller may provide a token which was previously issued by the designated recipient and stored in a token log within the communication processor 1002. The token log may also include settings for the specific token, such as about how to handle calls which go unanswered.

The token settings within the token log may indicate that, due to the importance of the person to whom the token was issued, that any calls unanswered at the first communication device 1008 should be automatically routed to the second communication device 1010. This helps the recipient avoid missing important calls coming in to the first communication device 1008 when the recipient is away from that device.

Less important calls may arrive with no token or with tokens having a setting of not automatically forwarding unanswered calls. In this case, the recipient would not be bothered on the recipients mobile communication device 1010 with such calls, but those calls could be simply forwarded to a message recording system. Again, the idea of this invention is to automatically manage incoming calls by issuing tokes which are stored in a token log and can potentially be used with incoming calls.

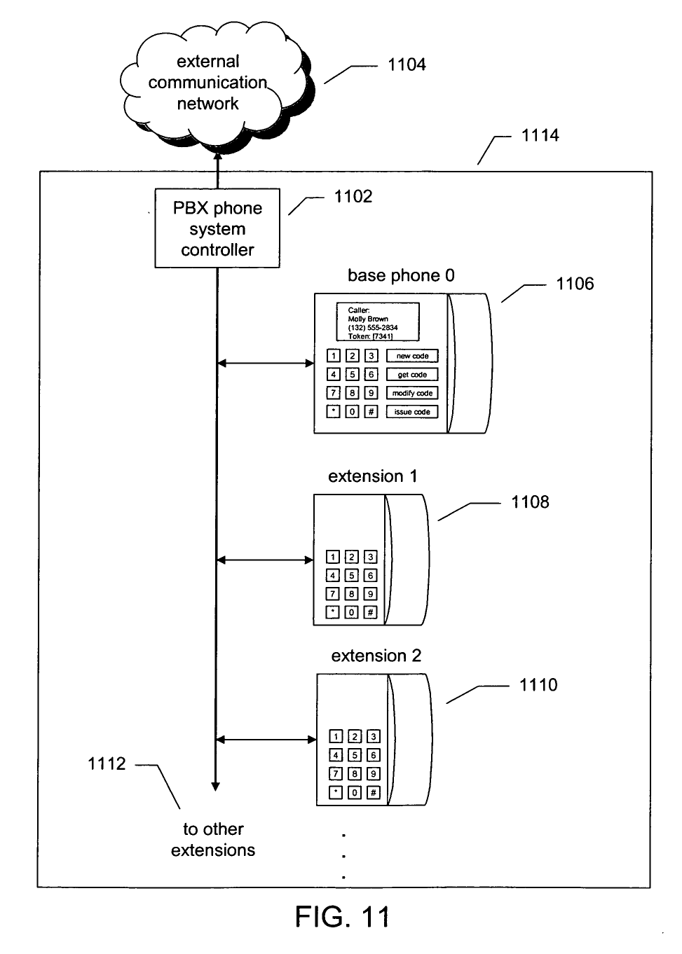

FIG. 11 shows a configuration of a token system within a multi-extension PBX phone system 1114, in one embodiment of this invention. A PBX controller 1102 is connected to an external communication network 1104. The PBX controller 1102 processes and routes communication coming from the external communication network 1104 and going to that network. The PBX system possibly includes one or more base phones 1106 and one or more regular extensions 1108, 1110. The difference between a base phone 1106 and regular extension phones is that the base phone allows configuration of the PBX control system. Various other phones can be attached to the system 1112.

The FIG. 11 diagram as described in the prior paragraph is similar to PBX systems that have been in use for many years; the way this invention makes a PBX system new and unique is by using tokens to control the processing calls coming into the PBX system. As described previously, the PBX system 1114 allows the creation and storage tokens which are distributed to entities who potentially desire to communicate with users of the PBX system. For example, if it is a business PBX system, key customers may be given specific tokens for use when calling the business.

Also as described, specific tokens can be associated in a token log with settings which define how incoming calls including a given token are processed. Examples of processing options pertaining to a PBX system may include the following:
Which extension the incoming call should ring first.
How to route unanswered calls among the various extensions.
When to route incoming calls to voicemail and which extension to signal that a voicemail message has been recorded.
and so forth.

Of course, the types of processing described previously could also be used in a PBX embodiment. Further, treatments can be defined and associated with given tokens in a token log. Treatments pertaining to a PBX implementation may include the following.
“Standard” treatment: ring all extensions with “ring” tone for up to three rings, followed by a “please leave a message” outgoing message followed by up to 60 seconds of incoming message recording time. Tokens associated with this treatment can be issued to regular customers and suppliers.
“Important” treatment: ring all extensions with distinctive ring tone for up to eight rings, followed by “please leave a message, or press 0 to reach a receptionist . . . ” outgoing message followed by up to 120 seconds of incoming message recording time. Tokens associated with this treatment can be issued to the most important customers.
“Message-only” treatment: ring no extensions, but directly say the “please leave a message and we will get back with you” outgoing message followed up to 60 seconds of incoming message recording time. Tokens with this treatment might be published in company product-support literature, allowing an employee to batch the processing of such calls.
and so forth.

The token log and/or treatment definitions can be stored anywhere within the PBX system 1114, although in one reasonable embodiment they would be part of the controller 1102.

Similar to what was discussed with FIG. 1 and FIG. 2, the description of an embodiment of the invention with a PBX phone system FIG. 11 could also be applied to an embodiment within a company intranet, for processing voice, text, and/or video messages. Instead of phone extensions, the system would contain one or more communication devices, with issued tokens possibly determining the routing of messages among the communication devices.

While specific embodiments and applications of the present invention have been illustrated and described, it is to be understood that the invention is not limited to the precise configuration and components disclosed herein. Various modifications, changes, and variations apparent to those skilled in the art may be made in the arrangement, operation, and details of the methods and systems of the present invention disclosed herein without departing from the spirit and scope of the invention.

What is claimed is:

1. A method in a communication system comprising:
detecting a communication originating from a caller and intended for a designated recipient;
receiving from the caller a token which was previously generated and stored in a token log within the communication system and made available to one or more potential callers of the designated recipient, which token is comprised of one or more codes that, when taken together, are distinct from both the caller's network identifier and the designated recipient's network identifier;
attempting to locate the received token in the token log; and
automatically processing the communication in a specific way based on locating the received token in the token log and checking one or more conditions occurring within the communication system.

2. The method of claim 1 wherein each network identifier is one or more of a phone number, an instant messaging username, and a text messaging address.

3. The method of claim 1 wherein the communication system transfers messages from senders to recipients over one or more public or private networks.

4. The method of claim 1 wherein automatically processing the incoming communication in a specific way comprises one or more of providing the caller with an automated response message, transferring the caller to a message recording system, allowing the caller to record a message of up to a specified length, forwarding the incoming communication to a different network identifier, and attempting to signal the specified recipient by one or more of audible stimuli, visual stimuli, and tactile stimuli.

5. The method in claim 1, wherein at least one of the conditions comprises one or more of the caller's network identifier being from a set of one or more network identifiers associated with the token, the time at which the token is received being within a specified time range, and the number of times the token has been previously received with incoming calls being below a designated limit.

6. The method of claim 1 wherein a recipient's communication device is a component of the communication system which is accessible by the recipient.

7. The method of claim 6 wherein the recipient's communication device comprises one or more of a mobile phone, a wired phone, a facsimile machine, and a computing device configured with communication software.

8. The method of claim 6 wherein one or more of the conditions comprises the recipient's communication device being in one or more of a set of one or more specific modes at the time the token is received.

9. The method of claim 8 wherein the mode of the recipient's communication device indicates that the recipient is one or more of in a meeting, driving a vehicle, at work, at home, asleep, and on vacation.

10. The method of claim 8 wherein the mode of the recipient's communication device is manually set by an operator of the communication device.

11. The method of claim 8 wherein the mode of the recipient's communication device is automatically set according to one or more of a predefined mode-setting time schedule, and the current operational status of the recipient's communication device.

12. The method of claim 11 wherein the operational status of the recipient's communication devices comprises one or more of ready to receive communication, busy handling a conversation, and temporarily disabled from communicating.

13. The method of claim 1 wherein one or more of the conditions comprises the caller indicating a specified purpose for the communication.

14. The method of claim 13 wherein the specified purpose comprises one or more of calling to have a conversation, calling to leave a message, and calling to relay an urgent message.

15. The method of claim 1 wherein one or more of the conditions comprises identifying a specified treatment associated with the token within the communication system, which treatment is associated with one or more settings within the communication system.

16. The method of claim 15 wherein the specified treatment indicates a relationship between the specified recipient and the one or more potential callers of the communication system.

17. The method of claim 15 wherein the specified treatment indicates which actions should be used to process the incoming communication according to one or more of the current mode of the recipient's communication device and a purpose indicated by the caller.

18. The method of claim 1 further comprising:
detecting a second communication originating from a second caller intended for the designated recipient, which second communication is not accompanied by a token that is stored in the token log within the communication system; and
automatically processing the second communication in a way which is specified for incoming communications not accompanied by a token that is stored within the communication system.

19. A communications system comprising:
a token log for recording settings that are associated with specific tokens;
a token generating module for generating tokens;
a user interface that allows a device operator to associate one or more specific settings with one or more specific tokens;
a data module that provides storage and retrieval of tokens and associated settings;
a processing module that responds to incoming calls according to settings specified in the token log.

20. A communication system comprising:
means for detecting a communication originating from a caller and intended for a designated recipient;
means for receiving from the caller a token which was previously generated by an operator of the communication system and stored in a token log within the communication system and made available to one or more potential callers of the designated recipient, which token is comprised of one or more codes that, when taken together, are distinct from both the caller's network identifier and the designated recipient's network identifier;
means for attempting to locate the received token in the token log; and
means for automatically processing the communication in a specific way based on locating the received token in the token log and checking one or more conditions occurring within the communication system.
